(19) United States
(12) Patent Application Publication
(10) Pub. No.: US 2005/0238896 A1
(43) Pub. Date: Oct. 27, 2005

(54) Polyimide film and method for production thereof, and polyimide/metal laminate using polyimide

(76) Inventors: Toshihisa Itoh, Kyoto-shi (JP); Kan Fujihara, Otsu-shi (JP); Kazuhiro Ono, Otsu-shi (JP); Shirou Sasaki, Takashima-gun (JP); Kiyokazu Akahori, Otsu-shi (JP)

Correspondence Address: HOGAN & HARTSON L.L.P., 500 S. GRAND AVENUE, SUITE 1900, LOS ANGELES, CA, 90071-2611, US

(21) Appl. No.: 10/514,929

(22) PCT Filed: May 20, 2003
(86) PCT No.: PCT/JP03/06261

§ 371 Date: Nov. 12, 2004

(30) Foreign Application Priority Data
May 21, 2002 (JP) 2002-146914
May 31, 2002 (JP) 2002-160452

(51) Int. Cl. B32B 27/00

(52) U.S. Cl. 428/473.5

(57) ABSTRACT

A polyimide film having improved adhesion strength is produced by forming a partially cured and/or dried gel film using a first polyamic acid solution; coating the gel film with the second polyamic acid solution or immersing the gel film in the second polyamic acid solution; and heating the gel film applied with the second polyamic acid solution. By laminating a metal by vapor deposition, sputtering, ion plating, or the like, directly on the polyimide film, a polyimide/metal laminate is provided which has excellent dimensional stability and in which reliability with respect to adhesion between the polyimide film and the metal is improved.

### TECHNICAL FIELD

The present invention relates to a polyimide film, a method for producing the same, and a polyimide/metal laminate including the polyimide film. More particularly, the invention relates to a polyimide film used for a polyimide/metal laminate formed by laminating a metal directly on the polyimide film serving as a base film by vacuum deposition, sputtering, ion plating, or the like, the polyimide film exhibiting excellent adhesion to the metal and capable of retaining the adhesion after thermal loading for a long period of time or after exposure to a high-temperature, high-humidity environment; a method for producing the polyimide film; and a polyimide/metal laminate including the polyimide film.

### BACKGROUND ART

Polyimide films have heat resistance, insulating properties, solvent resistance, low-temperature resistance, etc. and therefore are widely used as insulating bases for computers and components of IC-controlled electrical and electronic apparatuses, for example, as base films for flexible printed circuit boards (FPCs) and tapes for tape automated bonding (TAB). With the recent reduction in size and increase in functionality of electrical apparatuses, finer wiring patterns and higher packaging densities of electronic components on wiring boards have been required. As packaging techniques for electronic components, COF (chip on FPC) and TCP (tape carrier package) techniques have been established and used for packaging of driving elements for liquid crystal displays (LCDs), plasma displays (PDPs), etc.

In the packaging techniques described above, further increases in fineness of wiring and packaging densities of electronic components are taking place. In order to meet the requirement of finer pattern of wiring and higher packaging densities, use of a substrate in which a metal layer is directly laminated on a polyimide film without an adhesive, i.e., a two-layered substrate, for COF and TCP has been under study. The two-layered substrate can meet the decrease in the thickness of the metal layer and therefore can meet the increase in the wiring density.

That is, in a conventional three-layered substrate in which an adhesive layer is disposed between a polyimide film and a metal layer, if a voltage bias is applied under high-temperature and high-pressure conditions, short-circuiting occurs between interconnections due to diffusion of metal ions in the adhesive layer. Consequently, an increase in the wiring density is limited. On the other hand, the two-layered substrate does not have an adhesive layer and therefore is becoming widely used as a technique that overcomes the drawback of the conventional three-layered substrate. Because of the advantage described above, the two-layered substrate is not only applied to the packaging techniques for components but also applied to wireless HDD suspensions, cartridges for ink-jet printers, etc.

However, the two-layered substrate has a drawback in that the metal layer directly laminated on the polyimide film easily separates from the polyimide film. That is, adhesion between the polyimide film and the metal in the two-layered substrate is weaker than that in the three-layered substrate. Accordingly, various techniques have been proposed in order to improve adhesion strength between the polyimide film and the metal.

For example, Japanese Unexamined Patent Application Publication No. 5-295142 (Publication Date: Nov. 9, 1993), Japanese Unexamined Patent Application Publication No. 9-36539 (Publication Date: Feb. 7, 1997), and Japanese Unexamined Patent Application Publication No. 10-204646 (Publication Date: Aug. 4, 1998) each disclose a method of modifying a surface of a polyimide film by a wet process using an alkaline solution. Japanese Unexamined Patent Application Publication No. 11-117060 (Publication Date: Apr. 27, 1999) discloses a method of modifying a surface of a polyimide film by plasma treatment. Japanese Unexamined Patent Application Publication No. 6-124978 (Publication Date: May 6, 1994), etc., discloses a method of applying a polyimide or a polyamic acid, which is a precursor of the polyimide, to a surface of a polyimide film. Furthermore, Japanese Unexamined Patent Application Publication No. 2001-277424 (Publication Date: Oct. 9, 2001) discloses a method in which a surface of a polyimide film is roughened. According to each of the patent application publications, the method requires an improvement step for modifying the surface of the polyimide film by post-processing, and residues of organic substances may remain on the surface of the polyimide film after the improvement step. The adhesion strength between the polyimide film and the metal is still insufficient after the improvement step.

On the other hand, a technique for improving adhesion strength between a polyimide film and a metal by improving adhesiveness of the polyimide film itself without the improvement step in the post process as described above is disclosed in Japanese Unexamined Patent Application Publication No. 06-073209 (Publication Date: Mar. 15, 1994), Japanese Unexamined Patent Application Publication No. 08-330728 (Publication Date: Dec. 13, 1996), etc. That is, according to these publications, adhesiveness of a polyimide film in an ordinary state is improved by incorporating an organotin compound into the polyimide film. However, the technique in each of the publications has a problem in that the organotin compound is converted into a harmful tin compound by the use of the organotin compound or in the step of forming the polyimide film.

Japanese Patent No. 1948445 (Registration Date: Jul. 10, 1995; Publication No.: Japanese Unexamined Patent Application Publication No. 62-129352, Publication Date: Jun. 11, 1985) discloses a technique for improving adhesiveness of a polyimide film in an ordinary state by incorporating an organotitanium compound into the polyimide film. However, incorporation of the organotitanium compound gives rise to problems, such as serious coloration and embrittlement of the polyimide film.

Furthermore, Japanese Unexamined Patent Application Publication No. 2000-326442 (Publication Date: Nov. 28, 2000) discloses a method for improving adhesiveness of a polyimide film itself by treating a surface of a cast sheet (gel film) with a solution of an organotitanium compound before being converted into the polyimide film.

It is possible to improve adhesion strength between a polyimide film and a metal in an ordinary state by using the method according to any one of the patent application publications. Furthermore, it is highly likely that the two-layered substrate is subjected to long-term thermal load or exposed to a high-temperature, high-humidity environment. Therefore, it is desired that the two-layered substrate has excellent adhesion strength between the polyimide film and the metal after thermal loading for a long period of time or after exposure to a high-temperature, high-humidity environment.

In order to manufacture a polyimide film, a method may be employed in which an organic solvent solution of a polyamic acid, which is a precursor of a polyimide, is cast onto a substrate and partially cured and/or dried so as to have self-supporting properties to produce a gel film, and the gel film is subjected to a treatment for modifying a surface of the polyimide film.

For example, Japanese Unexamined Patent Application Publication No. 48-7067 (Publication Date: Jan. 29, 1973) discloses a method of coating a gel film with a polyamic acid. Japanese Unexamined Patent Application Publication No. 10-58628 (Publication Date: Mar. 3, 1998) discloses a technique in which a polyamic acid solution is applied to a gel film to produce a multilayered polyimide film including a surface layer composed of an amorphous polyimide. Furthermore, Japanese Unexamined Patent Application Publication No. 2000-43211 (Publication Date: Feb. 15, 2000) discloses a technique which enables to provide a polyimide film having good adhesiveness by applying a polyamic acid solution to a gel film.

However, the technique according to each of the patent application publications has a problem regarding dimensional stability of the polyimide film because the change in dimension due to moisture absorption and the water absorption are not sufficiently low. Furthermore, neither of the patent application publications describes an improvement in the adhesion strength between the polyimide film and the metal in the two-layered substrate when the metal layer is directly laminated on the polyimide film without an adhesive. Moreover, in view of the process of mounting components on two-layered substrates and an expansion in the application of apparatuses including two-layered substrates, it is desired to improve reliability in adhesion strength between the polyimide film and the metal after thermal loading for a long period of time or after exposure to a high-temperature, high-humidity environment. However, neither of the patent application publications describes the improvement in reliability.

In view of the facts that the densities of wiring and mounted components are increasing, that two-layered substrates are used in harsh environments, and that processing conditions are strict when wiring is patterned and components are mounted on the two-layered substrates, the polyimide films used for the two-layered substrates must have high dimensional stability. In order to meet the requirement for high dimensional stability, it is important for the polyimide film 1) to have a sufficiently low coefficient of linear expansion equal to that of the metal layer and 2) to have a small change in dimension due to stress. In addition to the heat and stress characteristics (dimensional stability) 1) and 2), it is important 3) to have a small change in dimension due to moisture absorption and 4) to have a low water absorption in itself.

In order to obtain the characteristics 1) to 4), for example, Japanese Unexamined Patent Application Publication No. 2001-72781 (Publication Date: Mar. 21, 2001) discloses a polyimide film produced using, as a starting monomer, p-phenylenebis(trimellitic acid monoester anhydride), which is an acid anhydride, or its analogs. Although it is possible to obtain the characteristics 1) to 4) and thus to produce a polyimide film having excellent dimensional stability by using the acid anhydride or its analog, as described above, the two-layered substrate requires strong adhesion between the polyimide film and the metal. In particular, satisfactory adhesion is desirably maintained in the operating environment of the two-layered substrate and even after exposure to a high-temperature environment and a high-temperature, high humidity environment for processing the two-layered substrate.

The present invention has been achieved in order to overcome the problems associated with the conventional techniques described above. It is an object of the present invention to improve adhesion strength between the polyimide film and the metal of a polyimide/metal laminate, which is a two-layered substrate, in an ordinary state and even after exposure to a high-temperature environment and a high-temperature, high-humidity environment. It is another object of the present invention to provide a polyimide film having particularly excellent dimensional stability in an operating environment when the polyimide film is used for a polyimide/metal laminate, a method for producing the polyimide film, and a polyimide/metal laminate including the polyimide film.

### DISCLOSURE OF INVENTION

In view of the problems described above, the present inventors have conducted intensive research. As a result, it has been found that, in a polyimide/metal laminate in which a metal layer is directly laminated on a polyimide film without an adhesive, by using a polyimide film prepared using an organic solvent solution of a polyamic acid, excellent durability is shown after exposure to a high-temperature environment and a high-temperature, high-humidity environment, and that excellent environmental resistance is shown with respect to adhesion strength between the polyimide film and the metal. Thus, the present invention has been completed.

That is, a polyimide film of the present invention is produced by casting a first polyamic acid solution onto a substrate, the first polyamic acid solution being prepared using a first acid dianhydride component containing at least pyromellitic dianhydride and a first diamine component containing at least p-phenylenediamine and 4,4′-diaminodiphenyl ether; partially curing and/or drying the cast first polyamic acid solution so as to have self-supporting properties to form a gel film; and coating at least one surface of the gel film with the second polyamic acid solution or immersing the gel film in the second polyamic acid solution, the second polyamic acid solution being prepared using a second acid dianhydride component containing at least one acid dianhydride and a second diamine component containing at least one diamine.

In accordance with the structure described above, it is possible to provide a polyimide film which has excellent reliability and excellent dimensional stability in an ordinary state and after exposure to a high-temperature environment and a high-temperature, high-humidity environment.

A polyimide/metal laminate of the present invention includes the polyimide film described above and a metal layer directly laminated on the polyimide film.

The polyimide film of the present invention can provide excellent dimensional stability to the polyimide/metal laminate including the polyimide film. The polyimide film of the present invention can also provide excellent adhesion strength to the interface between the polyimide film and the metal layer in the polyimide/metal laminate in an ordinary state and also after exposure to a high-temperature environment and a high-temperature, high-humidity environment.

Further objects, features and merits of the present invention will become fully evident from the following description. Advantages of the present invention will become apparent from the following description.

### BEST MODE FOR CARRYING OUT THE INVENTION

An embodiment of the present invention will be described in detail below. It is to be understood that the present invention is not limited thereto.

A polyimide film of the present invention is produced by casting a first solution of a polyamic acid (polyamide acid) (hereinafter referred to as a first polyamic acid solution) onto a substrate, partially curing and/or drying the cast first polyamic acid solution so as to have self-supporting properties to form a gel film (cast sheet); and applying a second solution of a polyamic acid (hereinafter referred to as a second polyamic acid solution) by coating or the like to at least one surface of the gel film. Specifically, the polyimide film of the present invention is obtained by further performing heating treatment after the second polyamic acid solution is applied to the surface of the gel film.

The polyimide film of the present invention can be used as a polyimide/metal laminate, which is a two-layered substrate, by directly laminating a metal layer on at least one surface of the polyimide film, i.e., both surfaces or one surface of the polyimide film.

Below are detailed descriptions of (1) first polyamic acid solution, (2) gel film, (3) second polyamic acid solution, (4) method for producing polyimide film, and (5) polyimide/metal laminate.

(1) First Polyamic Acid Solution

The first polyamic acid solution contains a polyamic acid, which is a precursor of a polyimide, and is used to form a gel film. The polyamic acid (hereinafter referred to as the first polyamic acid) contained in the first polyamic acid solution may be any known polyamic acid and is not particularly limited.

That is, the first polyamic acid solution can be obtained by dissolving substantially equimolar amounts of a first acid dianhydride component containing at least pyromellitic dianhydride and a first diamine component containing at least p-phenylenediamine and 4,4′-diaminodiphenyl ether in an appropriate solvent to prepare a mixed solution, and stirring the mixed solution until polymerization between the first acid dianhydride component and the first diamine component is completed.

The first acid dianhydride component must contain at least pyromellitic dianhydride and may contain an acid dianhydride other than the pyromellitic dianhydride (hereinafter referred to as the other acid dianhydride). The other acid dianhydride is preferably an aromatic acid dianhydride, and more preferably an aromatic tetracarboxylic acid dianhydride, although not limited thereto.

Specific examples of the other acid dianhydride include 3,3′,4,4′-benzophenonetetracarboxylic dianhydride, 3,3′,4,4′-biphenyltetracarboxylic dianhydride, 4,4′-oxydiphthalic anhydride, 2,3,3′,4′-biphenyltetracarboxylic dianhydride, 2,3,3′,4′-benzophenonetetracarboxylic dianhydride, 3,3′,4,4′-diphenylsulfonetetracarboxylic dianhydride, 2,3,6,7-naphthalenetetracarboxylic dianhydride, and 1,4,5,8-naphthalenetetracarboxylic dianhydride. One or two of these other acid dianhydrides may be used as the first acid dianhydride component.

Among the other acid dianhydrides described above, preferably, at least one of 3,3′,4,4′-benzophenonetetracarboxylic dianhydride and 3,3′,4,4′-biphenyltetracarboxylic dianhydride is used. Thereby, it becomes possible to subtly control the physical properties, such as the coefficient of linear expansion, modulus of elasticity in tension, and tensile elongation, of the resulting polyimide film.

In order to improve mechanical strength and heat resistance of the resulting polyimide film, the pyromellitic dianhydride is used in an amount of preferably 50 mole percent or more, more preferably 70 mole percent or more, still more preferably 80 mole percent or more, and most preferably 90 mole percent or more, of the total acid dianhydrides in the first acid dianhydride component.

The other acid dianhydride may be used in any percentage together with the pyromellitic dianhydride used in the percentage described above. However, when at least one of 3,3′,4,4′-benzophenonetetracarboxylic dianhydride and 3,3′,4,4′-biphenyltetracarboxylic dianhydride is used as the other acid dianhydride, the content of the other acid dianhydride in the first acid dianhydride component is set at preferably 30 mole percent or less, more preferably 25 mole percent or less, still more preferably 20 mole percent or less, and most preferably 10 mole percent or less, of the total acid dianhydrides in the first acid dianhydride component. Preferably, physical properties of the resulting polyimide film is subtly controlled by using 3,3′,4,4′-benzophenonetetracarboxylic dianhydride and/or 3,3′,4,4′-biphenyltetracarboxylic dianhydride in an amount of 30 mole percent or less of the total dianhydrides.

Furthermore, the first acid dianhydride component may contain p-phenylenebis(trimellitic acid monoester anhydride) as an essential constituent in addition to pyromellitic dianhydride. By setting the essential constituents of the first acid dianhydride component to be pyromellitic dianhydride and p-phenylenebis(trimellitic acid monoester anhydride), the resulting polyimide film is allowed to have an excellent coefficient of linear expansion and modulus of elasticity in tension, and it is possible to provide excellent dimensional stability to a polyimide/metal laminate including the polyimide film.

When the first acid dianhydride component contains pyromellitic dianhydride and p-phenylenebis(trimellitic acid monoester anhydride), the total amount of these two acid dianhydrides is preferably 75 mole percent or more, more preferably 80 mole percent or more, and most preferably 90 mole percent or more, of the total acid dianhydrides in the first acid dianhydride component. If the total amount is less than 75 mole percent, it is difficult to allow the resulting polyimide film to have a sufficiently low coefficient of linear expansion and high modulus of elasticity in tension and to provide high dimensional stability to the polyimide/metal laminate.

Although the mixing ratio between pyromellitic dianhydride and p-phenylenebis(trimellitic acid monoester anhydride) is not particularly limited, as described above, pyromellitic dianhydride is preferably used in an amount of 50 mole percent or more of the total acid dianhydrides in the first acid dianhydride component. Consequently, when p-phenylenebis(trimellitic acid monoester anhydride) is further used for the first acid dianhydride component, in view of the facts that the coefficient of linear expansion of the resulting polyimide film can be decreased; the modulus of elasticity of the resulting polyimide film can be increased; and in particular, the coefficient of hygroscopic expansion and the water absorption of the resulting polyimide film can be decreased, the p-phenylenebis(trimellitic acid monoester anhydride) is used in an amount of preferably 25 mole percent or more, more preferably 35 mole percent or more, and most preferably 45 mole percent or more, of the total acid dianhydrides.

The first diamine component used for obtaining the first acid dianhydride component must contain at least p-phenylenediamine and 4,4′-diaminodiphenyl ether and may contain a diamine other than p-phenylenediamine and 4,4′-diaminodiphenyl ether (hereinafter referred to as the other diamine).

The other diamine is preferably an aromatic diamine although not limited thereto. Specific examples of the other diamine include 4,4′-diaminodiphenylpropane, 4,4′-diaminodiphenylmethane, benzidine, 3,3′-dichlorobenzidine, 4,4′-diaminodiphenylsulfide, 3,3′-diaminodiphenylsulfone, 4,4′-diaminodiphenylsulfone, 3,3′-diaminodiphenyl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 1,3-diaminobenzene, 1,2-diaminobenzene, 1,4-diaminobenzene(p-phenylenediamine), 4,4′-bis(3-aminophenoxy)diphenylsulfone, 4,4′-bis(4-aminophenoxy)diphenylsulfone, 2,2′-bis(4-aminophenoxyphenyl)propane, and analogs thereof. One or two of these other diamines may be used together with p-phenylenediamine and 4,4′-diaminodiphenyl ether as the first diamine component.

With respect to the mixing ratio between 4,4′-diaminodiphenyl ether and p-phenylenediamine in the first diamine component, the lower limit of the molar ratio of (4,4′-diaminodiphenyl ether)/(p-phenylenediamine) is preferably 0.2 or more, more preferably 0.3 or more, still more preferably 0.5 or more, and most preferably 0.7 or more. The upper limit of the ratio of (4,4′-diaminodiphenyl ether)/(p-phenylenediamine) is preferably 9.5 or less, more preferably 5.0 or less, still more preferably 4.0 or less, and most preferably 3.0 or less.

If the molar ratio of (4,4′-diaminodiphenyl ether)/(p-phenylenediamine) deviates from the range described above, the balance between film formability, and flexibility and mechanical strength of the resulting polyimide film becomes lost, which is not desirable.

Preferably, the content of the other diamine in the first diamine component is 20 mole percent or less.

The polyamic acid (hereinafter referred to as the first polyamic acid) contained in the first polyamic acid solution is obtained by dissolving the first acid dianhydride component and the first diamine component in an appropriate solvent to prepare a mixed solution, and stirring the mixed solution. That is, preparation of the mixed solution and stirring of the mixed solution cause condensation between the individual acid dianhydrides and diamines contained in the first acid dianhydride component and the first diamine component to yield the first polyamic acid.

The condensation between the individual acid dianhydrides and diamines is performed under known temperature conditions. The stirring time corresponds to the period during which polymerization is completed between the acid dianhydrides and diamines.

The solvent for obtaining the first polyamic acid solution in which the polyamic acid is dissolved, i.e., the solvent for dissolving the first acid dianhydride component and the first diamine component to synthesize the first polyamic acid, is preferably an organic solvent capable of dissolving the first acid dianhydride component, the first diamine component, and the first polyamic acid. In the present invention, the dissolved state includes a state in which the solvent has completely dissolved solutes (acid dianhydride component, diamine component, and polyamic acid) and a substantially dissolved state in which solutes are homogeneously dispersed or diffused in the solvent.

Preferable examples of the solvent include amide solvents, such as N,N-dimethylformamide, N,N-dimethylacetamide, and N-methyl-2-pyrrolidone. Among them, N,N-dimethylformamide is particularly preferable. A solvent, such as toluene, tetrahydrofuran, 2-propanol, 1-butanol, ethyl acetate, or acetylacetone, may be further added thereto in such an amount that does not decrease the solubility.

The resulting first polyamic acid solution usually contains 15% to 25% by weight of the polyamic acid. If the concentration of the first polyamic acid solution is in the range described above, the first polyamic acid solution has an appropriate solution viscosity, and it is possible to obtain a first polyamic acid with an appropriate molecular weight.

(2) Gel Film

When the first polyamic acid solution containing a polyamic acid, which is a precursor of a polyimide, is applied onto a substrate by flow casting, a resin film is formed on the substrate. Subsequently, when the resin film on the substrate is heated and dried, the resin film is partially cured and/or dried so as to have self-supporting properties, and a “gel film” is thereby obtained.

More specifically, a chemical conversion agent and a catalyst are mixed into the first polyamic solution as necessary, and the mixed solution is cast onto a substrate, such as a glass plate, aluminum foil, metal endless belt, or metal drum, to form a resin film. Subsequently, by heating the resin film on the substrate, the resin film can be partially cured and/or dried. In this process, by heating the substrate itself or applying hot air or far-infrared radiation heat to the resin film, the curing reaction of the resin film can be accelerated.

In view of mechanical strength, etc., of the resulting polyimide film, a “chemical imidization method” in which a chemical conversion agent and a catalyst are incorporated as described above is preferably used. Examples of the chemical conversion agent to be added to the first polyamic acid solution include acid anhydrides, such as acetic anhydride. Examples of the catalyst include tertiary amines, such as isoquinoline, β-picoline, and pyridine.

As described above, the resin film cast onto the substrate is heated and dried on the substrate and partially cured and/or dried so as to have self-supporting properties. As a result, a gel film is obtained.

The gel film is in an intermediate state during the curing process from the polyamic acid into the polyimide. That is, the gel film is partially imidized and contains residual volatile components, such as an organic solvent and a catalyst.

The “partially imidized” state can be evaluated by the imidization rate, which is calculated, using infrared absorption spectrometry, in accordance with the following formula:
(A/B)/(C/D)×100
(wherein A represents the absorption peak height of the gel film at 1,370 cm⁻¹; B represents the absorption peak height of the gel film at 1,500 cm⁻¹; C represents the absorption peak height of the polyimide film at 1,370 cm⁻¹; and D represents the absorption peak height of the polyimide film at 1,500 cm⁻¹). Specifically, in the “partially imidized” state, the imidization rate calculated according to the above formula is 50% or more, preferably 70% or more, more preferably 80% or more, still more preferably 85% or more, and most preferably 90% or more.

If the imidization rate is less than 50%, the gel film is difficult to peel off from the substrate, or self-supporting properties of the gel film are extremely poor. As the imidization rate becomes close to 100%, the gel film tends to spontaneously peel off from the substrate.

The residual volatile content of the gel film is calculated in accordance with the following formula:
(E−F)×100/F(%)
(wherein E represents the weight of the gel film; and F represents the weight of the gel film after being heated at 450° C. for 20 minutes). The film to be used suitably has a residual volatile content of 20% to 200%, preferably 30% to 100%, and most preferably 30% to 70%.

If the residual volatile content exceeds 200%, self-supporting properties become poor, and problems, such as elongation and breaking, occur when the gel film is transported to a heating furnace or the like. Thus, it becomes difficult to stably produce the polyimide film. Although a residual volatile content of lower than 20% is acceptable, if the residual volatile content is lower than 20%, the gel film spontaneously peels off from the substrate and rapid shrinkage easily occurs, which is undesirable.

(3) Second Polyamic Acid Solution

The second polyamic acid solution is applied on at least one surface of the gel film obtained using the first polyamic acid solution by coating or immersing the gel film into the second polyamic acid solution.

The second polyamic acid solution of the present invention can be obtained by dissolving substantially equimolar amounts of a second acid dianhydride component containing at least one acid dianhydride and a second diamine component containing at least one diamine in an appropriate solvent to prepare a mixed solution, and stirring the mixed solution until polymerization between the second acid dianhydride component and the second diamine component is completed.

The acid dianhydride in the second acid dianhydride component is preferably an aromatic acid dianhydride, although not limited thereto. Use of at least one acid dianhydride selected from the group consisting of pyromellitic dianhydride, 3,3′,4,4′-biphenyltetracarboxylic dianhydride, and 3,3′,4,4′-benzophenonetetracarboxylic dianhydride is particularly preferable. Among them, in particular, incorporation of 3,3′,4,4′-benzophenonetetracarboxylic dianhydride in the second acid dianhydride component improves not only adhesion strength in an ordinary state but also environmental resistance, thus being preferable.

The diamine in the second diamine component is preferably an aromatic diamine which is capable of providing heat resistance to the resulting polyimide film, although not limited thereto. Examples of the aromatic diamine include 4,4′-diaminodiphenylpropane, 4,4′-diaminodiphenylmethane, benzidine, 3,3′-dichlorobenzidine, 4,4′-diaminodiphenylsulfide, 3,3′-diaminodiphenylsulfone, 4,4′-diaminodiphenylsulfone, 4,4′-diaminodiphenyl ether, 3,3′-diaminodiphenyl ether, 3,4′-diaminodiphenyl ether, 1,5-diaminonaphthalene, 4,4′-diaminodiphenyldiethylsilane, 4,4′-diaminodiphenylsilane, 4,4′-diaminodiphenylethylphosphine oxide, 4,4′-diaminodiphenyl-N-methylamine, 4,4′-diaminodiphenyl-N-phenylamine, 1,4-diaminobenzene(p-phenylenediamine), 1,3-diaminobenzene, 1,2-diaminobenzene, 4,4′-bis(4-aminophenoxy)diphenylsulfone, 4,4′-bis(3-aminophenoxy)diphenylsulfone, 2,2′-bis(4-aminophenoxyphenyl)propane, p-phenylenediamine, and analogs thereof. These diamines may used alone or in combination of two of them in any percentage.

Among the diamines described above, aromatic diamines having flexible groups are preferably used to produce polyimide films. Specifically, at least one of 4,4′-diaminodiphenylpropane, 4,4′-diaminodiphenylmethane, 4,4′-diaminodiphenyl ether, 3,4′-diaminodiphenyl ether, 4,4′-diaminodiphenylethylphosphine oxide, 4,4′-diaminodiphenylsulfide, 3,3′-diaminodiphenylsulfone, 4,4′-bis(4-aminophenoxy)diphenylsulfone, 4,4′-bis(3-aminophenoxy)diphenylsulfone, and 2,2′-bis(4-aminophenoxyphenyl)propane is preferably used. In particular, at least one of 4,4′-diaminodiphenyl ether, 4,4′-bis(3-aminophenoxy)diphenylsulfone, 2,2′-bis(4-aminophenoxyphenyl)propane, p-phenylenediamine, and analogs thereof is most preferably used.

By using the aromatic diamine described above, flexibility can be imparted to the polyimide film, adhesion between the polyimide film and the metal in the polyimide/metal laminate which will be described below can be improved, and reliability of the polyimide/metal laminate can be improved.

The content of the aromatic diamine is preferably 50 mole percent or more, more preferably 75 mole percent or more, still more preferably 80 mole percent or more, and most preferably 90 mole percent or more, of the total diamines in the second diamine component.

Additionally, the second acid dianhydride component and the second diamine component may contain, respectively, at least one of the other acid dianhydrides and at least one of the other diamines which may be contained in the first acid dianhydride component and the first diamine component (refer to item (1) described above) in any percentage. That is, the second acid anhydride component may be the same as or different from the first acid dianhydride component, and the second diamine component may be the same as or different from the first diamine component.

The polyamic acid (hereinafter referred to as the second polyamic acid) contained in the second polyamic acid solution of the present invention is obtained by dissolving the second acid dianhydride component and the second diamine component in an appropriate solvent to prepare a mixed solution, and stirring the mixed solution. That is, preparation of the mixed solution and stirring of the mixed solution cause condensation between the individual acid dianhydrides and diamines contained in the second acid dianhydride component and the second diamine component to yield the second polyamic acid. The temperature conditions and the stirring time in the above process may be determined according to the known conditions.

The solvent for obtaining the second polyamic acid solution in which the polyamic acid is dissolved, i.e., the solvent for dissolving the second acid dianhydride component and the second diamine component to synthesize the second polyamic acid, may be any organic solvent capable of dissolving the second acid dianhydride component, the second diamine component, and the second polyamic acid.

Specific examples of the solvent include amide solvents, such as N,N-dimethylformamide, N,N-dimethylacetamide, and N-methyl-2-pyrrolidone. These may be used alone or in combination of two or more in any percentage. A solvent, such as toluene, tetrahydrofuran, 2-propanol, 1-butanol, ethyl acetate, or acetylacetone, may be further added thereto in such an amount that does not decrease the solubility. The solvent may be the same as or different from the solvent used for the first polyamic acid solution.

The concentration of the second polyamic acid solution is preferably 0.1% to 10.0% by weight and may be appropriately adjusted depending on the method of application to the gel film and the desired appearance of the resulting polyimide film. The concentration of the second polyamic acid solution is more preferably 0.5% to 5% by weight, still more preferably 1.0% to 3.0% by weight, and most preferably 1.5% to 2.5% by weight.

Furthermore, in view of appearance and workability, the viscosity of the second polyamic solution determined with a rotational BH viscometer is preferably 1 to 100 centipoises, more preferably 5 to 80 centipoises, and most preferably 10 to 50 centipoises, at a measurement temperature of 20° C.

(4) Method for Producing Polyimide Film

A polyimide film of the present invention is produced by a method including a step of coating at least one surface of the gel film with the second polyamic acid solution or immersing the gel film in the second polyamic acid solution to apply the second polyamic solution on the surface of the gel film; and a step of heating the gel film.

Specifically, the coating may be performed by gravure coating, spray coating, knife coating, or the like. Among them, in view of control of coating weight and uniformity, gravure coating is particularly preferable.

The coating weight of the second polyamic acid solution is preferably 0.1 to 100 g/m², and more preferably 1 to 10 g/m². If the coating weight is out of the range described above, in a polyimide/metal laminate including the resulting polyimide film and a metal layer disposed thereon, it is difficult to achieve a balance between the improvement in adhesion of the polyimide film to the metal and the appearance of the polyimide film.

Alternatively, the gel film may be immersed in the second polyamic acid solution. When the application by immersion is performed, a common dip coating process may be used. Specifically, the gel film is immersed in a vessel containing the second polyamic acid solution continuously or in batch processing. In such a case, the immersion time is preferably 1 to 100 seconds, and more preferably 1 to 20 seconds. If the immersion time is out of the range described above, it is difficult to achieve a balance between the improvement in adhesion of the polyimide film to the metal and the appearance of the polyimide film.

In order to obtain a polyimide film which is free from any irregularity on the surface thereof and thus excellent in the appearance, preferably, a step of removing the excess solution remaining on the surface of the polyimide film is further performed. The solution removal step is particularly effective when the dip coating process is used. Specifically, the solution removal step is carried out by a known process, such as squeezing with nip rollers, an air knife process, a doctor blade process, wiping, or suction.

After completing the individual steps described above, the edges of the gel film applied with the second polyamic acid solution are fixed, and in order to avoid shrinkage of the gel film during curing, water, the residual solvent, the residual chemical conversion agent, and the catalyst are removed. Each of the polyamic acid (first polyamic acid) in the gel film and the polyamic acid (second polyamic acid) applied on the surface of the gel film is then completely converted into a polyimide, and a polyimide film of the present invention is thereby prepared.

As the imidization method, in view of mechanical properties, such as toughness and tensile strength at break, of the polyimide film and productivity, use of a chemical imidization method is particularly preferable. Appropriate imidization conditions may be set depending on the types of the polyamic acids, the thickness of the gel film, etc.

Preferably, the first and second polyamic acids are completely converted into polyimides by heat treatment according to a known process, in which, in a heating furnace, heating is performed stepwise and successively, and finally, at high temperatures for a short period of time. Preferably, at the initial stage of the treatment in the heating furnace, the temperature is set at about 150° C. to 350° C. to remove the remaining solvent, etc., by drying; the temperature is gradually or stepwise increased; and finally, in the high-temperature heating furnace at a temperature of about 450° C. to 620° C., heating is performed for 15 to 400 seconds.

When the heating temperature in the high-temperature heating furnace is higher than the optimum range described above or when the heating time is longer than the optimum heating time described above, thermal degradation of the resulting polyimide film may occur, resulting in a decrease in mechanical strength. On the other hand, when the heating temperature is lower than the optimum range described above or when the heating time is extremely short, complete imidization is not achieved. As a result, it may be difficult to improve adhesion between the polyimide film and the metal in the polyimide/metal laminate, and it may not be possible to obtain sufficient mechanical strength and heat resistance of the polyimide film.

Furthermore, inorganic or organic fillers, plasticizers such as organophosphorus compounds, and antioxidants may be added, by a known method, to the polyimide film produced by any one of the various methods described above. The polyimide film may be subjected to known physical surface treatment, such as corona discharge treatment or plasma discharge treatment, or chemical surface treatment, such as priming, so that improved characteristics are imparted thereto.

The thickness of the polyimide film produced by the method described above may be set appropriately depending on the application. The thickness of the polyimide film is preferably 5 to 300 μm, more preferably 5 to 125 μm, and still more preferably 7.5 to 50 μm.

With respect to the polyimide film produced by each of the methods described above, in a range of 100° C. to 200° C., the lower limit of the coefficient of linear expansion can be set at 5 ppm, and is preferably 10 ppm, and most preferably 14 ppm. The upper limit of the coefficient of linear expansion can be set at 25 ppm, and is preferably 20 ppm, and most preferably 18 ppm. The coefficient of linear expansion in this range is equal to that of a copper thin film or the like.

Furthermore, with respect to the polyimide film produced using the first polyamic acid solution containing p-phenylenebis(trimellitic acid monoester anhydride) as an essential constituent in addition to pyromellitic dianhydride, the coefficient of hygroscopic expansion, which corresponds to a change in dimension due to moisture absorption, can be set at 15 ppm or less, preferably 10 ppm or less, and most preferably 8 ppm or less. The water absorption of the polyimide film can be reduced to 3.0% or less, preferably 2.0% or less, and most preferably 1.5% or less. Furthermore, the lower limit of the coefficient of linear expansion of the polyimide film, in a range of 100° C. to 200° C., can be set at 5 ppm. The upper limit of the coefficient of linear expansion can be set at 25 ppm, and preferably 15 ppm. The lower limit of the modulus of elasticity in tension of the polyimide film is 4.5 GPa, and preferably 5.0 GPa. The upper limit of the modulus of elasticity intension is 7.5 GPa, and preferably 7.0 GPa.

Consequently, in the polyimide film of the present invention, by incorporating pyromellitic dianhydride into the first polyamic acid solution, high dimensional stability can be imparted to the polyimide/metal laminate including the polyimide film.

(5) Polyimide/Metal Laminate

The polyimide/metal laminate of the present invention will now be described below.

The polyimide/metal laminate of the present invention includes the polyimide film produced by any one of the methods described above and a metal layer laminated on one or both surfaces of the polyimide film. The polyimide/metal laminate can be produced by any method known to those skilled in the art. For example, a metal is directly laminated on an polyimide in ordinary film by vacuum deposition, sputtering, ion plating, or plating. The polyimide/metal laminate of the present invention exhibits an excellent adhesion when the metal layer is directly disposed on the polyimide film so that the polyimide film and the metal layer are in contact with each other. However, the metal layer may be formed by laminating a metal foil to the polyimide film with an adhesive.

The metal layer may be composed of one metal, or two or more metals may be sequentially laminated. Alternatively, two or more metals may be mixed to form an alloy, and then the alloy may be laminated.

When one metal is used, the type of the metal is not particularly limited. Use of copper is particularly preferable. When a metal layer (hereinafter referred to as a metal layer A) in which two or more metals are sequentially laminated is formed, the metal layer A includes a metal layer A1 which is directly laminated so as to be in contact with the polyimide film and serves as an underlying metal layer and a metal layer A2 laminated on the metal layer A1.

The metal contained in the metal layer A1 is not particularly limited. Preferable examples thereof include nickel, chromium, cobalt, palladium, molybdenum, tungsten, titanium, zirconium, alloys of these metals, and compounds of these metals. More preferable examples thereof include nickel, nickel-chromium alloys, nickel compounds, chromium, chromium alloys, and chromium compounds. Preferably, at least one metal selected from these groups is laminated as the metal layer A1 on the polyimide film, and for example, a copper layer is laminated as the metal layer A2 on the metal layer A1.

The thickness of the metal layer is preferably in a range of 3 to 50 μm, and more preferably in a range of 3 to 35 μm, although not particularly limited thereto. The method for forming the metal layer is not particularly limited. The metal layer A (e.g., including the metal layer A1 and the metal layer A2) may be formed by vacuum deposition, ion plating, or sputtering. Furthermore, the metal layer preferably includes a metal plating layer formed by plating on the metal layer A.

The total thickness of the metal layer A1 and the metal layer A2 is preferably in a range of 10 to 100,000 Å (1 Å (angstrom)=1×10⁻⁴ μm), more preferably in a range of 50 to 100,000 Å, and still more preferably in a range of 100 to 50,000 Å. The metal plating layer may be formed with a desired thickness.

When the metal layer is formed using one metal, the metal layer A1 and the metal plating layer are composed of the same metal without providing the metal layer A2. When the metal layer is formed using two metals, the metal layer A1 is composed of a metal that is different from the metal which constitutes the metal layer A2 and the metal plating layer.

Furthermore, before forming the underlying metal layer, the surface of the polyimide film may be subjected to pretreatment, such as washing, annealing, corona discharge treatment, or plasma treatment, using a known technique for the purpose of cleaning, physical modification, chemical modification, or the like.

With respect to the polyimide/metal laminate formed by the method described above, when the wiring pattern formed by etching the metal layer has a pattern width of 1 mm, in an ordinary state, the adhesion strength at the pattern width of 1 mm is 5.0 N/cm or more, which is favorable. The adhesion strength is preferably 6.0 N/cm or more, more preferably 7.0 N/cm or more, and most preferably 8.0 N/cm or more.

After exposure to an environment at 121° C. and 100% RH for 96 hours, the polyimide/metal laminate can retain 50% or more, preferably 60% or more, and more preferably 75% or more of the adhesion strength before exposure. Furthermore, when the wiring pattern formed on the metal layer has a pattern width of 1 mm, after exposure to an environment at 150° C. for 168 hours, the polyimide/metal laminate can retain 50% or more, preferably 60% or more, and more preferably 75% or more of the adhesion strength before exposure at the pattern width of 1 mm.

As described above, the polyimide/metal laminate of the present invention is excellent in reliability both in an ordinary state and after exposure to a high-temperature environment and a high-temperature, high-humidity environment.

As described above, by producing a polyimide/metal laminate including the polyimide film of the present invention and a metal layer directly laminated, for example, by vacuum deposition or sputtering, on the polyimide film, it is possible to obtain a highly reliable polyimide/metal laminate or flexible printed circuit board having durability in harsh environments, such as in a high-temperature, high-humidity environment. Furthermore, since the polyimide film of the present invention has a low coefficient of linear expansion, high dimensional stability can be imparted to the polyimide/metal laminate.

While the present invention will be described specifically based on the examples and comparative examples below, it is to be understood that the present invention is not limited thereto.

First, in the examples and comparative examples, various properties of polyimide films were measured by the methods described below.

[Coefficient of Linear Expansion]

The coefficient of linear expansion of a polyimide film was measured using a thermomechanical analyzer, TMA-8140, manufactured by Rigaku Corporation. Specifically, the temperature was raised at 10° C./min from room temperature to 400° C., and then decreased to room temperature. The temperature was raised again under the same conditions, and the coefficient of linear expansion was determined in a temperature range of 100° C. to 200° C.

[Coefficient of Hygroscopic Expansion]

A polyimide film was cut out in a size of 5 mm×20 mm. The polyimide film was allowed to absorb moisture at 35% RH until complete saturation was achieved while applying a minimum weight (3.0 g) that did not cause sagging of the polyimide film, and the initial size was measured (at 50° C.). Subsequently, the humidity was controlled to 90% RH. The polyimide film was similarly allowed to absorb moisture until complete saturation was achieved, and the size after moisture absorption was measured (at 50° C.). The above sizes were measured with a TMA (TMC-140) manufactured by Shimadzu Corporation.

The rate of change in dimension per % relative humidity was calculated from both the initial size and the size after moisture absorption, and the coefficient of hygroscopic expansion was thereby determined.

[Modulus of Elasticity in Tension]

The modulus of elasticity in tension was evaluated according to JIS C-2318.

[Water Absorption]

The water absorption was measured according to ASTM D570.

Next, the synthesis examples of solutions of first polyamic acids and second polyamic acids, which are precursors of polyimides, as well as the examples and comparative examples will be described. In the synthesis examples, examples, and comparative examples, the individual compounds are abbreviated as below. In each of the synthesis examples, synthesis was performed at a reaction temperature of 5° C. to 10° C., in a dry nitrogen atmosphere.
DMF: N,N-dimethylformamide
DMAC: N,N-dimethylacetamide
PMDA: pyromellitic dianhydride
BPDA: 3,3′,4,4′-biphenyltetracarboxylic dianhydride
BTDA: 3,3′,4,4′-benzophenonetetracarboxylic dianhydride
TMHQ: p-phenylenebis(trimellitic acid monoester anhydride)
ODA: 4,4′-diaminodiphenyl ether
p-PDA: p-phenylenediamine
BAPS: 4,4′-bis(3-aminophenoxy)diphenylsulfone

### SYNTHESIS EXAMPLE 1

In a 2,000-mL separable flask was placed 68.4 g of ODA, and 700 g of DMF was added thereto for dissolution. Next, 99.3 g of PMDA in the form of powder was added thereto, and the reaction was allowed to take place for one hour with stirring. A solution separately prepared by dissolving 12.3 g of p-PDA in 120 g of DMF was added thereto so as not to increase the reaction temperature, and stirring was performed for 2 hours to complete the reaction. Thereby, a DMF solution of a PMDA/ODA/p-PDA (composition ratio: 100/75/25) polyamic acid (resin concentration: 18%) was prepared.

### SYNTHESIS EXAMPLE 2

In a 2,000-mL separable flask was placed 72.7 g of ODA and 9.8 g of p-PDA, and 765 g of DMAc was added thereto for dissolution. BPDA (13.5 g) was further added thereto, and the reaction was allowed to take place for three hours. Subsequently, 84.6 g of PMDA in the form of powder was added thereto, and the reaction was allowed to take place for 30 minutes until complete dissolution was achieved. A solution separately prepared by dissolving 4.5 g of PMDA in 50 g of DMAc was added thereto, and stirring was performed for 2 hours to complete the reaction. Thereby, a DMAc solution of a PMDA/BPDA/ODA/p-PDA (composition ratio: 90/10/80/20) polyamic acid (resin concentration: 18.5%) was prepared.

### SYNTHESIS EXAMPLE 3

In a 1,500-mL separable flask was placed 71.8 g of ODA, and 350 g of DMF was added thereto for dissolution. Subsequently, 78.2 g of PMDA in the form of powder was added thereto, and stirring was performed for 2 hours to complete the reaction. Thereby, a solution of a PMDA/ODA (composition ratio: 100/100) polyamic acid (resin concentration: 30%) was prepared.

### SYNTHESIS EXAMPLE 4

In a 1,500-mL separable flask was placed 60.7 g of ODA, and 350 q of DMF was added thereto for dissolution. Subsequently, 89.3 g of BPDA in the form of powder was added thereto, and stirring was performed for 5 hours to complete the reaction. Thereby, a DMF solution of a BPDA/ODA (composition ratio: 100/100) polyamic acid (resin concentration: 30%) was prepared.

### SYNTHESIS EXAMPLE 5

In a 1,500-mL separable flask was placed 57.5 g of ODA, and 350 g of DMF was added thereto for dissolution. Subsequently, 92.5 g of BTDA in the form of powder was added thereto, and stirring was performed for 2 hours to complete the reaction. Thereby, a solution of a BTDA/ODA (composition ratio: 100/100) polyamic acid (resin concentration: 30%) was prepared.

### SYNTHESIS EXAMPLE 6

In a 1,500-mL separable flask was placed 44.4 g of ODA and 24.0 g of BAPS, and 350 g of DMF was added thereto for dissolution. Subsequently, 81.6 g of BPDA in the form of powder was added thereto, and stirring was performed for 5 hours to complete the reaction. Thereby, a solution of a BPDA/ODA/BAPS (composition ratio: 100/80/20) polyamic acid (resin concentration: 30%) was prepared.

### SYNTHESIS EXAMPLE 7

In a 2,000-mL separable flask was placed 56.4 g of ODA and 30.5 g of p-PDA, and 1,123 g of DMAc was added thereto for dissolution under stirring. Further, 129.1 g of TMHQ in the form of powder was added thereto, and the reaction was allowed to take place for 2 hours while the TMHQ is being dissolved. Subsequently, 55.4 g of PMDA in the form of powder was added thereto, and the reaction was allowed to take place until complete dissolution was achieved. A solution separately prepared by dissolving 6.1 g of PMDA in 100 g of DMAc was added thereto so as not to increase the reaction temperature, and stirring was performed for 2 hours to complete the reaction. Thereby, a DMAc solution of a PMDA/TMHQ/ODA/p-PDA (feed composition ratio: 50/50/50/50) polyamic acid (resin concentration: 18.5%) was prepared.

### SYNTHESIS EXAMPLE 8

In a 2,000-mL separable flask was placed 40.24 g of ODA and 7.2 g of p-PDA, and 1,000 g of DMAc was added thereto for dissolution. Further, 95.9 g of TMHQ in the form of powder was added thereto, and the reaction was allowed to take place for 2 hours while the TMHQ is being dissolved. Next, 10.1 g of ODA and 40.2 g of p-PDA were added thereto, and stirring was performed for 30 minutes. Subsequently, 52.8 g of PMDA in the form of powder was added thereto, and the reaction was allowed to take place until complete dissolution was achieved. A solution separately prepared by dissolving 5.7 g of PMDA in 190 g of DMAc was added thereto so as not to increase the reaction temperature, and stirring was performed for 2 hours to complete the reaction. Thereby, a DMAc solution of a PMDA/TMHQ/ODA/p-PDA (feed composition ratio: 40/60/50/50) polyamic acid (resin concentration: 15.0%) was prepared.

### SYNTHESIS EXAMPLE 9

In a 2,000-mL separable flask was placed 49.4 g of ODA and 21.8 g of p-PDA, and 1,000 g of DMAC was added thereto for dissolution. BPDA (13.2 g) was further added thereto, and the reaction was allowed to take place for three hours. Next, 71.9 g of TMHQ in the form of powder was added thereto, and the reaction was allowed to take place for 1 hour. Subsequently, 48.4 g of PMDA in the form of powder was added thereto, and the reaction was allowed to take place for 30 minutes until complete dissolution was achieved. A solution separately prepared by dissolving 5.4 g of PMDA in 190 g of DMAc was added thereto, and stirring was performed for 2 hours to complete the reaction. Thereby, a DMAc solution of a PMDA/TMHQ/BPDA/ODA/p-PDA (composition ratio: 55/35/10/55/45) polyamic acid (resin concentration: 15.0%) was prepared.

### COMPARATIVE EXAMPLE 1

To 150 g of the PMDA/ODA/p-PDA polyamic acid solution prepared in Synthesis Example 1 was added a mixed solution of a converting agent composed of 23.2 g of acetic anhydride, 6.4 g of β-picoline, and 66.8 g of DMF, and mixing was performed while stirring under cooling at 0° C. The resulting composition containing the polyamic acid solution and the converting agent was applied onto an aluminum foil to form a resin film, using a comma coater. The thickness of the resin film was set at about 0.2 mm so that the resulting polyimide film had a thickness of 25 μm. After the resin film disposed on the aluminum foil was heated at 140° C., the resin film was peeled off from the aluminum foil. A gel film having a residual volatile content of 50% and an imidization rate of 88% was thereby obtained.

The edges of the gel film were fixed on a frame equipped with pins, and heating was performed at 250° C., 350° C., and 550° C., each for one minute. A polyimide film with a thickness of 25 μm was thereby obtained. The properties of the resulting polyimide film are shown in Table 1 below.

### COMPARATIVE EXAMPLE 2

To 150 g of the PMDA/BPDA/ODA/p-PDA polyamic acid solution prepared in Synthesis Example 2 was added a mixed solution of a converting agent composed of 24.0 g of acetic anhydride, 12.2 g of isoquinoline, and 38.8 g of DMAc, and mixing was performed while stirring under cooling at 0° C. Using the resulting composition containing the polyamic acid solution and the converting agent, a polyimide film with a thickness of 25 μm was obtained as in Comparative Example 1. The properties of the resulting polyimide film are shown in Table 1.

### EXAMPLE 1

The PMDA/ODA polyamic acid solution prepared in Synthesis Example 3 was diluted with DMF so that the resin concentration was 1.5%, and thereby a polyamic acid dilute solution (second polyamic acid solution) with a rotational concentration (determined with a BH viscometer manufactured by Tokyo Keiki) of 28 centipoises was obtained. After a gel film which is the same as that in Comparative Example 1 was immersed in a vessel charged with the dilute solution, excess droplets were removed with nip rollers, and heat treatment was performed under the same conditions as those in Comparative Example 1. A polyimide film with a thickness of 25 μm was thereby produced. The properties of the resulting polyimide film are shown in Table 1.

### EXAMPLE 2

A polyimide film with a thickness of 25 μm was produced as in Example 1 except for the use of a polyamic acid dilute solution with a viscosity of 20 centipoises obtained by diluting the BPDA/ODA polyamic acid solution prepared in Synthesis Example 4 with DMF so that the resin concentration was 1.5%. The properties of the resulting polyimide film are shown in Table 1.

### EXAMPLE 3

A polyimide film with a thickness of 25 μm was produced as in Example 1 except for the use of a polyamic acid dilute solution with a viscosity of 25 centipoises obtained by diluting the BTDA/ODA polyamic acid solution prepared in Synthesis Example 5 with DMF so that the resin concentration was 2.0%. The properties of the resulting polyimide film are shown in Table 1.

### EXAMPLE 4

A polyimide film with a thickness of 25 μm was produced as in Example 1 except for the use of a polyamic acid dilute solution with a viscosity of 22 centipoises obtained by diluting the BPDA/ODA/BAPS polyamic acid solution prepared in Synthesis Example 6 with DMF so that the resin concentration was 2.0%. The properties of the resulting polyimide film are shown in Table 1.

### EXAMPLE 5

A polyimide film with a thickness of 25 μm was produced under the same conditions as those in Comparative Example 2 except for the use of the same PMDA/ODA polyamic acid dilute solution as that used in Example 1 and for the inclusion of a step of immersing the gel film as in Example 1. The properties of the resulting polyimide film are shown in Table 1.

### EXAMPLE 6

A polyimide film with a thickness of 25 μm was produced under the same conditions as those in Comparative Example 2 except for the use of the same BPDA/ODA polyamic acid dilute solution as that used in Example 2 and for the inclusion of a step of immersing the gel film as in Example 1. The properties of the resulting polyimide film are shown in Table 1.

### EXAMPLE 7

A polyimide film with a thickness of 25 μm was produced under the same conditions as those in Comparative Example 2 except for the use of the same BTDA/ODA polyamic acid dilute solution as that used in Example 3 and for the inclusion of a step of immersing the gel film as in Example 1. The properties of the resulting polyimide film are shown in Table 1.

### EXAMPLE 8

A polyimide film with a thickness of 25 μm was produced under the same conditions as those in Comparative Example 2 except for the use of the same BPDA/ODA/BAPS polyamic acid dilute solution as that used in Example 4 and for the inclusion of a step of immersing the gel film as in Example 1. The properties of the resulting polyimide film are shown in Table 1.

TABLE 1

| | | | | Coefficient | |
|---|---|---|---|---|---|
| | | | Coefficient of | of | |
| | | | linear | hygroscopic | Modulus of |
| | | Polyamic acid dilute | expansion | expansion | elasticity |
| | Gel film | solution | (ppm) | (ppm) | (GPa) |
| Comparative | PMDA/ODA/ | None | 17.2 | 15.2 | 3.9 |
| Example 1 | p-PDA | | | | |
| Example 1 | (Synthesis | PMDA/ODA | 16.9 | 14.9 | 3.8 |
| | Example 1) | (Synthesis Example 3) | | | |
| Example 2 | | BPDA/ODA | 17.0 | 14.8 | 3.9 |
| | | (Synthesis Example 4) | | | |
| Example 3 | | BTDA/ODA | 16.8 | 15.0 | 3.9 |
| | | (Synthesis Example 5) | | | |
| Example 4 | | BPDA/ODA/BAPS | 17.0 | 16.1 | 3.5 |
| | | (Synthesis Example 6) | | | |
| Comparative | PMDA/BPDA/ | None | 16.3 | 14.6 | 3.6 |
| Example 2 | ODA/p-PDA | | | | |
| Example 5 | (Synthesis | PMDA/ODA | 15.9 | 14.5 | 3.7 |
| | Example 2) | (Synthesis Example 3) | | | |
| Example 6 | | BPDA/ODA | 16.1 | 14.8 | 3.8 |
| | | (Synthesis Example 4) | | | |
| Example 7 | | BTDA/ODA | 15.8 | 14.2 | 3.6 |
| | | (Synthesis Example 5) | | | |
| Example 8 | | BPDA/ODA/BAPS | 16.4 | 16.0 | 3.5 |
| | | (Synthesis Example 6) | | | |

As is evident from the results shown in Table 1, even if a gel film, which is a precursor of a polyimide, is subjected to a special step in which the gel film is coated with the polyamic acid dilute solution or the gel film is immersed in the polyamic acid dilute solution, properties, such as the modulus of elasticity, coefficient of linear expansion, and coefficient of hygroscopic expansion, of the polyimide film, which are important when the polyimide film is used for a polyimide/metal laminate, do not change.

Consequently, by using the polyimide film of the present invention, it is possible to produce a polyimide/metal laminate which has a low coefficient of linear expansion, for example, substantially equal to that of a copper thin film which is most extensively used as the metal layer, and which has a small dimensional change and high accuracy even if being subjected to a step of forming a wiring pattern by etching the metal layer, a step of mounting electronic components, harsh environments in use, high-temperature or high-temperature, high-humidity conditions, and other various conditions and environments.

### COMPARATIVE EXAMPLE 3

To 150 g of the PMDA/TMHQ/ODA/p-PDA polyamic acid solution prepared in Synthesis Example 7 was added a mixed solution of a converting agent composed of 18.1 g of acetic anhydride, 6.6 g of β-picoline, and 56.9 g of DMF, and mixing was performed while stirring under cooling at 0° C. The resulting composition containing the polyamic acid solution and the converting agent was applied onto an aluminum foil to form a resin film, using a comma coater. The thickness of the resin film was set at about 0.2 mm so that the resulting polyimide film had a thickness of 25 μm. After the resin film disposed on the aluminum foil was heated at 140° C., the resin film was peeled off from the aluminum foil. A gel film having a residual volatile content of 50% and an imidization rate of 88% was thereby obtained.

The edges of the gel film were fixed on a frame equipped with pins, and heating was performed at 250° C., 350° C., and 550° C., each for one minute. A polyimide film with a thickness of 25 μm was thereby obtained. The properties of the resulting polyimide film are shown in Table 2 below.

### COMPARATIVE EXAMPLE 4

To 150 g of the PMDA/TMHQ/ODA/p-PDA polyamic acid solution prepared in Synthesis Example 8 was added a mixed solution of a converting agent composed of 19.0 g of acetic anhydride, 12.0 g of isoquinoline, and 43.95 g of DMAc, and mixing was performed while stirring under cooling at 0° C. The resulting composition containing the polyamic acid solution and the converting agent was applied onto an aluminum foil to form a resin film, using a comma coater. The thickness of the resin film was set at about 0.2 mm so that the resulting polyimide film had a thickness of 25 μm. After the resin film disposed on the aluminum foil was heated at 140° C., the resin film was peeled off from the aluminum foil. A gel film having a residual volatile content of 45% and an imidization rate of 90% was thereby obtained.

The edges of the gel film were fixed on a frame equipped with pins, and heating was performed at 250° C., 350° C., and 500° C., each for one minute. A polyimide film with a thickness of 25 μm was thereby obtained. The properties of the resulting polyimide film are shown in Table 2.

### COMPARATIVE EXAMPLE 5

To 150 g of the PMDA/TMHQ/BPDA/ODA/p-PDA polyamic acid solution prepared in Synthesis Example 9 was added a mixed solution of a converting agent composed of 19.0 g of acetic anhydride, 12.4 g of isoquinoline, and 43.0 g of DMAc, and mixing was performed while stirring under cooling at 0° C. Using the resulting composition containing the polyamic acid solution and the converting agent, a polyimide film with a thickness of 25 μm was obtained as in Comparative Example 4. The properties of the resulting polyimide film are shown in Table 2.

### EXAMPLE 9

The PMDA/ODA polyamic acid solution prepared in Synthesis Example 3 was diluted with DMF so that the resin concentration was 1.5%, and a polyamic acid dilute solution with a rotational concentration (determined with a BH viscometer manufactured by Tokyo Keiki) of 28 centipoises was thereby obtained. After a self-supporting film which was the same as that in Comparative Example 3 was immersed in a vessel charged with the dilute solution, excess droplets were removed with nip rollers, and heat treatment was performed under the same conditions as those in Comparative Example 3. A polyimide film with a thickness of 25 μm was thereby produced. The properties of the resulting polyimide film are shown in Table 2.

### EXAMPLE 10

A polyimide film with a thickness of 25 μm was produced as in Example 9 except for the use of a polyamic acid dilute solution with a viscosity of 20 centipoises obtained by diluting the BPDA/ODA polyamic acid solution prepared in Synthesis Example 4 with DMF so that the resin concentration was 1.5%. The properties of the resulting polyimide film are shown in Table 2.

### EXAMPLE 11

A polyimide film with a thickness of 25 μm was produced as in Example 9 except for the use of a polyamic acid dilute solution with a viscosity of 25 centipoises obtained by diluting the BTDA/ODA polyamic acid solution prepared in Synthesis Example 5 with DMF so that the resin concentration was 2.0%. The properties of the resulting polyimide film are shown in Table 2.

### EXAMPLE 12

A polyimide film with a thickness of 25 μm was produced as in Example 9 except for the use of a polyamic acid dilute solution with a viscosity of 22 centipoises obtained by diluting the BPDA/ODA/BAPS polyamic acid solution prepared in Synthesis Example 6 with DMF so that the resin concentration was 2.0%. The properties of the resulting polyimide film are shown in Table 2.

### COMPARATIVE EXAMPLE 6

A polyimide film with a thickness of 25 μm was produced as in Example 9 except for the use of a polyamic acid dilute solution with a viscosity of 28 centipoises obtained by diluting the PMDA/TMHQ/ODA/p-PDA polyamic acid solution prepared in Synthesis Example 7 with DMAc so that the resin concentration was 1.5%.

### EXAMPLE 13

A polyimide film with a thickness of 25 μm was produced under the same conditions as those in Comparative Example 4 except for the use of the same PMDA/ODA polyamic acid dilute solution as that used in Example 9 and for the inclusion of a step of immersing the gel film as in Example 9. The properties of the resulting polyimide film are shown in Table 2.

### EXAMPLE 14

A polyimide film with a thickness of 25 μm was produced under the same conditions as those in Comparative Example 4 except for the use of the same BPDA/ODA polyamic acid dilute solution as that used in Example 10 and for the inclusion of a step of immersing the gel film as in Example 9. The properties of the resulting polyimide film are shown in Table 2.

### EXAMPLE 15

A polyimide film with a thickness of 25 μm was produced under the same conditions as those in Comparative Example 4 except for the use of the same BTDA/ODA polyamic acid dilute solution as that used in Example 11 and for the inclusion of a step of immersing the gel film as in Example 9. The properties of the resulting polyimide film are shown in Table 2.

### EXAMPLE 16

A polyimide film with a thickness of 25 μm was produced under the same conditions as those in Comparative Example 4 except for the use of the same BPDA/ODA/BAPS polyamic acid dilute solution as that used in Example 12 and for the inclusion of a step of immersing the gel film as in Example 9. The properties of the resulting polyimide film are shown in Table 2.

### EXAMPLE 17

A polyimide film with a thickness of 25 μm was produced under the same conditions as those in Comparative Example 5 except for the use of the same PMDA/ODA polyamic acid dilute solution as that used in Example 9 and for the inclusion of a step of immersing the gel film as in Example 9. The properties of the resulting polyimide film are shown in Table 2.

### EXAMPLE 18

A polyimide film with a thickness of 25 μm was produced under the same conditions as those in Comparative Example 5 except for the use of the same BPDA/ODA polyamic acid dilute solution as that used in Example 10 and for the inclusion of a step of immersing the gel film as in Example 9. The properties of the resulting polyimide film are shown in Table 2.

### EXAMPLE 19

A polyimide film with a thickness of 25 μm was produced under the same conditions as those in Comparative Example 5 except for the use of the same BTDA/ODA polyamic acid dilute solution as that used in Example 11 and for the inclusion of a step of immersing the gel film as in Example 9. The properties of the resulting polyimide film are shown in Table 2.

### EXAMPLE 20

A polyimide film with a thickness of 25 μm was produced under the same conditions as those in Comparative Example 5 except for the use of the same BPDA/ODA/BAPS polyamic acid dilute solution as that used in Example 12 and for the inclusion of a step of immersing the gel film as in Example 9. The properties of the resulting polyimide film are shown in Table 2.

TABLE 2

| | | | | Coefficient | | |
|---|---|---|---|---|---|---|
| | | | Coefficient | of | Modulus | |
| | | | of linear | hygroscopic | of | Water |
| | | Polyamic acid dilute | expansion | expansion | elasticity | absorption |
| | Gel film | solution | (ppm) | (ppm) | (GPa) | (%) |
| Comparative | PMDA/TMHQ/ | None | 11.8 | 4.9 | 5.8 | 1.4 |
| Example 3 | ODA/p-PDA | | | | | |
| Example 9 | (Synthesis | PMDA/ODA | 12.0 | 5.1 | 5.7 | 1.5 |
| | Example 7) | (Synthesis Example 3) | | | | |
| Example 10 | | BPDA/ODA | 12.0 | 5.2 | 5.8 | 1.4 |
| | | (Synthesis Example 4) | | | | |
| Example 11 | | BTDA/ODA | 11.8 | 5.0 | 5.9 | 1.3 |
| | | (Synthesis Example 5) | | | | |
| Example 12 | | BPDA/ODA/ | 13.0 | 6.0 | 5.6 | 1.5 |
| | | BAPS | | | | |
| | | (Synthesis Example 6) | | | | |
| Comparative | PMDA/TMHQ/ | None | 11.5 | 6.1 | 6.4 | 1.2 |
| Example 4 | ODA/p-PDA | | | | | |
| Example 13 | (Synthesis | PMDA/ODA | 11.6 | 6.0 | 6.5 | 1.1 |
| | Example 8) | (Synthesis Example 3) | | | | |
| Example 14 | | BPDA/ODA | 12.0 | 5.2 | 6.4 | 1.2 |
| | | (Synthesis Example 4) | | | | |
| Example 15 | | BTDA/ODA | 11.3 | 6.0 | 6.5 | 1.2 |
| | | (Synthesis Example 5) | | | | |
| Example 16 | | BPDA/ODA/BAPS | 12.5 | 6.4 | 6.2 | 1.5 |
| | | (Synthesis Example 6) | | | | |
| Comparative | PMDA/TMHQ/ | None | 14.2 | 8.2 | 5.2 | 1.8 |
| Example 5 | BPDA/ODA/ | | | | | |
| Example 17 | p-PDA | PMDA/ODA | 14.0 | 8.0 | 5.4 | 1.8 |
| | (Synthesis | (Synthesis Example 3) | | | | |
| Example 18 | Example 9) | BPDA/ODA | 14.5 | 8.3 | 5.3 | 1.7 |
| | | (Synthesis Example 4) | | | | |
| Example 19 | | BTDA/ODA | 14.8 | 8.0 | 5.2 | 1.8 |
| | | (Synthesis Example 5) | | | | |
| Example 20 | | BPDA/ODA/ | 15.0 | 8.0 | 5.0 | 1.8 |
| | | BAPS | | | | |
| | | (Synthesis Example 6) | | | | |

As is evident from the results shown in Table 2, even if a gel film, which is a precursor of a polyimide, is subjected to a special step in which the gel film is coated with the polyamic acid dilute solution or the gel film is immersed in the polyamic acid dilute solution, properties, such as the modulus of elasticity, coefficient of linear expansion, coefficient of hygroscopic expansion, and water absorption, of the polyimide film, which are important when the polyimide film is used for a polyimide/metal laminate, do not change. Thus, excellent properties are retained.

### EXAMPLES 21 TO 40 AND COMPARATIVE EXAMPLES 7 TO 12

Using the polyimide films prepared in Comparative Examples 1 to 6 and Examples 1 to 20, polyimide/metal laminates (sputtering type) were produced according to the procedure described below, and the resulting polyimide/metal laminates were evaluated. The polyimide films of Comparative Examples 1 to 6 were respectively used in Comparative Examples 7 to 12. The polyimide films of Examples 1 to 20 were respectively used in Examples 21 to 40.

Nickel was laminated at a thickness of 100 Å on each of the polyimide films prepared in Comparative Examples 1 to 6 and Examples 1 to 20, and copper was laminated thereon at a thickness of 2,000 Å to form a metal layer A1, using a sputtering system (Model NSP-6, manufactured by Showa Shinku) equipped with an ion gun (Model NPS-3000FS) manufactured by IONTECH, Inc. Furthermore, a copper layer (thickness: 15 μm) was formed as a metal plating layer by electric copper sulfate plating (cathode current density 2 A/dm₂, plating time 40 min). Thereby, a polyimide/metal laminate of sputtering type (total thickness 40 μm) was formed as a copper-clad laminate including two layers.

After the resulting polyimide/metal laminate was subjected to a pressure cooker test (PCT) in which the polyimide/metal laminate was exposed to an environment at 121° C. and 100% RH for 96 hours, and after the polyimide/metal laminate was left to stand at 150° C. for 150 hours (after thermal load), adhesion strength between the polyimide and the metal was measured according to JIS C-6481. The adhesion strength was measured at a 90-degree peel angle with respect to a wiring pattern formed on the metal layer at a pattern width of 1 mm. For each of the polyimide/metal laminates, the observed adhesion strength was compared with the adhesion strength in an ordinary state. The results thereof are shown in Tables 3 and 4.

TABLE 3

| | | Adhesion strength | | |
|---|---|---|---|---|
| | | Ordinary | | |
| | Polyimide | state | After PCT | After thermal load |
| | film | (N/cm) | (N/cm) | (N/cm) |
| Comparative | Comparative | 8.5 | 2.0 | 1.8 |
| Example 7 | Example 1 | | | |
| Example 21 | Example 1 | 9.5 | 7.0 | 7.4 |
| Example 22 | Example 2 | 12.5 | 8.0 | 6.4 |
| Example 23 | Example 3 | 11.0 | 7.4 | 6.1 |
| Example 24 | Example 4 | 10.8 | 8.0 | 7.0 |
| Comparative | Comparative | 9.7 | 2.9 | 2.0 |
| Example 8 | Example 2 | | | |
| Example 25 | Example 5 | 10.9 | 6.5 | 6.7 |
| Example 26 | Example 6 | 12.0 | 8.5 | 6.9 |
| Example 27 | Example 7 | 11.9 | 7.6 | 6.0 |
| Example 28 | Example 8 | 12.0 | 8.0 | 7.0 |

TABLE 4

| | | Adhesion strength | | |
|---|---|---|---|---|
| | | Ordinary | | |
| | Polyimide | state | After PCT | After thermal load |
| | film | (N/cm) | (N/cm) | (N/cm) |
| Comparative | Comparative | 6.4 | 0.4 | 0.3 |
| Example 9 | Example 3 | | | |
| Example 29 | Example 9 | 7.2 | 4.0 | 4.0 |
| Example 30 | Example 10 | 8.0 | 4.5 | 5.1 |
| Example 31 | Example 11 | 7.5 | 5.0 | 4.3 |
| Example 32 | Example 12 | 8.1 | 5.2 | 4.0 |
| Comparative | Comparative | 5.1 | 0.2 | 0.5 |
| Example 10 | Example 4 | | | |
| Example 33 | Example 13 | 6.0 | 4.0 | 4.1 |
| Example 34 | Example 14 | 7.1 | 5.1 | 4.8 |
| Example 35 | Example 15 | 6.0 | 4.8 | 4.0 |
| Example 36 | Example 16 | 6.5 | 5.0 | 4.1 |
| Comparative | Comparative | 5.9 | 1.0 | 1.0 |
| Example 11 | Example 5 | | | |
| Example 37 | Example 17 | 6.6 | 3.9 | 4.0 |
| Example 38 | Example 18 | 7.1 | 4.2 | 3.7 |
| Example 39 | Example 19 | 7.2 | 4.4 | 3.5 |
| Example 40 | Example 20 | 7.0 | 4.5 | 3.0 |
| Comparative | Comparative | 7.0 | 0.8 | 0.0 |
| Example 12 | Example 6 | | | |

### EXAMPLES 41 TO 60 AND COMPARATIVE EXAMPLES 13 TO 18

Using the polyimide films prepared in Comparative Examples 1 to 6 and Examples 1 to 20, polyimide/metal laminates (vapor deposition type) were produced according to the procedure described below, and the resulting polyimide/metal laminates were evaluated. The polyimide films of Comparative Examples 1 to 6 were respectively used in Comparative Examples 13 to 18. The polyimide films of Examples 1 to 20 were respectively used in Examples 41 to 60.

Using an electron-beam heating evaporator (EBH-6, manufactured by Nippon Shinku), a nickel-chromium alloy (nickel/chromium=85/15) was deposited at a thickness of 50 Å on each of the polyimide films prepared in Comparative Examples 1 to 6 and Examples 1 to 20, and copper was then deposited at a thickness of 1,000 Å on the nickel-chromium alloy layer. Furthermore, a copper layer (thickness: 15 μm) was formed thereon by electric copper sulfate plating (cathode current density 2 A/dm², plating time 40 min). Thereby, a polyimide/metal laminate of vapor deposition type (total thickness 40 μm) was formed as a multilayer substrate including two copper layers. For each of the resulting polyimide/metal laminates, the adhesion strengths between the polyimide layer and the metal layer were evaluated in the same manner as that in Example 21. The results thereof are shown in Tables 5 and 6.

TABLE 5

| | | Adhesion strength | | |
|---|---|---|---|---|
| | | Ordinary | | After thermal |
| | | state | After PCT | load |
| | Polyimide film | (N/cm) | (N/cm) | (N/cm) |
| Comparative | Comparative | 6.9 | 0.8 | 0.8 |
| Example 13 | Example 1 | | | |
| Example 41 | Example 1 | 7.5 | 4.3 | 4.9 |
| Example 42 | Example 2 | 8.1 | 6.2 | 5.5 |
| Example 43 | Example 3 | 8.0 | 6.0 | 5.0 |
| Example 44 | Example 4 | 7.6 | 6.2 | 4.9 |
| Comparative | Comparative | 5.9 | 1.0 | 1.0 |
| Example 14 | Example 2 | | | |
| Example 45 | Example 5 | 7.0 | 4.2 | 4.0 |
| Example 46 | Example 6 | 7.5 | 4.2 | 3.9 |
| Example 47 | Example 7 | 7.4 | 5.0 | 3.9 |
| Example 48 | Example 8 | 7.7 | 5.0 | 3.3 |

TABLE 6

| | | Adhesion strength | | |
|---|---|---|---|---|
| | | Ordinary | | |
| | Polyimide | state | After PCT | After thermal load |
| | film | (N/cm) | (N/cm) | (N/cm) |
| Comparative | Comparative | 7.8 | 1.0 | 1.0 |
| Example 15 | Example 3 | | | |
| Example 49 | Example 9 | 9.0 | 6.9 | 7.0 |
| Example 50 | Example 10 | 11.4 | 7.7 | 6.0 |
| Example 51 | Example 11 | 9.4 | 6.1 | 5.5 |
| Example 52 | Example 12 | 9.2 | 6.0 | 5.1 |
| Comparative | Comparative | 8.0 | 0.2 | 0.9 |
| Example 16 | Example 4 | | | |
| Example 53 | Example 13 | 9.8 | 6.1 | 5.9 |
| Example 54 | Example 14 | 10.9 | 7.0 | 6.1 |
| Example 55 | Example 15 | 9.2 | 5.9 | 5.4 |
| Example 56 | Example 16 | 9.4 | 6.0 | 5.3 |
| Comparative | Comparative | 9.1 | 2.6 | 2.0 |
| Example 17 | Example 5 | | | |
| Example 57 | Example 17 | 9.9 | 6.0 | 6.2 |
| Example 58 | Example 18 | 10.5 | 7.2 | 6.6 |
| Example 59 | Example 19 | 9.8 | 5.9 | 6.0 |
| Example 60 | Example 20 | 9.9 | 5.9 | 5.8 |
| Comparative | Comparative | 9.8 | 2.0 | 1.8 |
| Example 18 | Example 6 | | | |

As is evident from the results shown in Tables 3 to 6, in the polyimide/metal laminate of the present invention, even after a high-temperature or high-temperature and high-humidity environmental test, a decrease in the adhesion strength of wiring pattern is small, and the polyimide/metal laminate is highly reliable.

The specific embodiments or examples in the Best Mode for Carrying Out the Invention section were described merely to clarify the technical content of the present invention, and it is to be understood that the invention is not limited to the disclosed embodiments or examples. On the contrary, the invention is intended to cover various modifications included within the spirit of the present invention and the scope of the appended claims.

### INDUSTRIAL APPLICABILITY

The polyimide film of the present invention has thermal expansibility that is most suitable when a metal layer is laminated on the polyimide film. Consequently, a polyimide/metal laminate including the polyimide film has excellent dimensional accuracy and environmental resistance. In particular, even after the polyimide/metal laminate is exposed to a high-temperature, high-humidity environment, excellent adhesion strength is exhibited.

If the first acid dianhydride component contains p-phenylenebis(trimellitic acid monoester anhydride), the polyimide/metal laminate is allowed to have excellent dimensional stability against humidity change as well as temperature change and a low water absorption in addition to the properties described above.

Therefore, by using the polyimide films of the present invention, it is possible to provide polyimide/metal laminates and flexible printed circuit boards which are suitable as circuits for electrical apparatuses operating even in harsh environments, such as in a high-temperature, high-humidity environment, without damage.

Consequently, the present invention is applicable, in addition to the polymer chemical industry which produces various resins and resin compositions, to the applied chemical industry which produces blending adhesive materials, resin sheets, laminates, etc., in the field of manufacture of electrical and electronic components, such as FPCs and build-up wiring boards, and in the field of manufacture of electrical and electronic apparatuses using these components.

1. A polyimide film produced by casting a first polyamic acid solution onto a substrate, the first polyamic acid solution being prepared using a first acid dianhydride component containing at least pyromellitic dianhydride and a first diamine component containing at least p-phenylenediamine and 4,4′-diaminodiphenyl ether; partially curing and/or drying the cast first polyamic acid solution
so as to have self-supporting properties to form a gel film; and coating at least one surface of the gel film with the second polyamic acid solution or immersing the gel film in the second polyamic acid solution, the second polyamic acid solution being prepared using a second acid dianhydride component containing at least one acid dianhydride and a second diamine component containing at least one diamine.

2. The polyimide film according to claim 1, wherein the second acid dianhydride component contains at least one acid dianhydride selected from the group consisting of pyromellitic dianhydride, 3,3′,4,4′-biphenyltetracarboxylic dianhydride, and 3,3′, 4,4′-benzophenonetetracarboxylic dianhydride.

3. The polyimide film according to claim 1, wherein the second diamine component contains at least 4,4′-diaminodiphenyl ether.

4. The polyimide film according to claim 1, wherein the polyimide film has a coefficient of linear expansion of 5 to 20 ppm in a range of 100° C. to 200° C.

5. The polyimide film according claim 1, wherein the first acid dianhydride component further contains p-phenylenebis (trimellitic acid monoester anhydride).

6. The polyimide film according to claim 5, wherein the polyimide film has a coefficient of hygroscopic expansion of 10 ppm or less.

7. The polyimide film according to claim 5, wherein the polyimide film has a water absorption of 2.0% or less.

8. The polyimide film according to claim 5, wherein the polyimide film has a coefficient of linear expansion of 5 to 15 ppm in a range of 100° C. to 200° C.

9. The polyimide film according to claim 5, wherein the polyimide film has a modulus of elasticity in tension of 4.5 to 7.0 GPa.

10. A polyimide/metal laminate comprising the polyimide film according to claim 1 and a metal layer directly laminated on the polyimide film.

11. The polyimide/metal laminate according to claim 10, wherein the metal layer comprises a metal layer A directly disposed on the polyimide film.

12. The polyimide/metal laminate according to claim 11, wherein the metal layer A comprises a metal layer A1 in contact with the polyimide film, and a metal layer A2 disposed on the metal layer A1.

13. The polyimide/metal laminate according to claim 12, wherein the metal constituting the metal layer A1 is different from the metal constituting the metal layer A2.

14. The polyimide/metal laminate according to claim 11, wherein the metal layer further comprises a metal plating layer formed on the metal layer A by plating.

15. The polyimide/metal laminate according to claim 10, wherein, when a wiring pattern having a width of 1 mm is formed by etching the metal layer, after exposure to an environment at 121° C. and 100% RH for 96 hours, the adhesion strength of the polyimide film to the wiring pattern is 60% or more of that before the exposure.

16. A method for producing a polyimide film comprising the steps of:
forming a gel film by casting a first polyamic acid solution onto a substrate and partially curing and/or drying the cast first polyamic acid solution so as to have self-supporting properties, the first polyamic acid solution being prepared using a first acid dianhydride component containing at least pyromellitic dianhydride and a first diamine component containing at least p-phenylenediamine and 4,4′-diaminodiphenyl ether;
coating at least one surface of the gel film with the second polyamic acid solution or immersing the gel film in the second polyamic acid solution, the second polyamic acid solution being prepared using a second acid dianhydride component containing at least one acid dianhydride and a second diamine component containing at least one diamine; and
heating the gel film applied with the second polyamic acid solution.

17. The method for producing the polyimide film according to claim 16, wherein the first acid dianhydride component further contains p-phenylenebis (trimellitic acid monoester anhydride).
